(19) United States
(12) Patent Application Publication
(10) Pub. No.: US 2006/0012283 A1
(43) Pub. Date: Jan. 19, 2006

(54) Oxide cathode

(75) Inventors: David Steven Barratt, Roosendale (GB); Matthew Stockwell, Seamer (GB)

Correspondence Address: Michael Best & Friedrich LLP, Suite 3300, 100 East Wisconsin Avenue, Milwaukee, WI, 53202-4108, US

(73) Assignees: L G PHILLIPS DISPLAYS NETHERLANDS BV, Eindhoven (NL); KONINKLIJKE PHILIPS ELECTRONICS NV, Eindhoven (NL)

(21) Appl. No.: 11/166,397

(22) Filed: Jun. 23, 2005

(30) Foreign Application Priority Data
Dec. 24, 2002 (GB) 0230125.7

(51) Int. Cl. H01J 1/14; H01J 1/20; H01J 29/16

(52) U.S. Cl. 313/355; 313/337; 313/346 R

(57) ABSTRACT

The invention provides an oxide cathode having an indirectly heated electron emitting layer disposed on a cathode base layer and an interface layer between the electron emitting layer and the base layer wherein the interface layer comprises a plurality of different chemical elements. The invention further provides a method of manufacturing an oxide cathode having an indirectly heated electron emitting layer disposed on a cathode base layer and an interface layer between the electron emitting layer and the base layer, the method comprising forming an interface layer comprising a plurality of chemical elements over the base layer, and forming an electron-emitting layer over the interface layer.

The invention relates to oxide cathodes which include an indirectly heated electron emitting layer disposed on a cathode base layer. In particular, but not exclusively, the invention relates to oxide cathodes for use in electron guns.

Conventional oxide cathodes generally comprise an oxide-containing electron-emitting layer (or coating) disposed on a metal base provided by a cathode body. A characteristic feature of the electron-emitting coating materials of oxide cathodes is that they comprise an alkaline earth metal in the form of an alkaline earth metal oxide. This is typically barium-oxide BaO but may comprise others such as SrO, CaO, Sc₂O₃, ThO₂, La₂O₃ and/or Y₂O₃. The metal base typically comprises nickel as a main component with a small quantity of reducing component such as magnesium Mg and/or silicon Si. Other suitable materials for the main component of the base include Mg, Al, Si, Re, Mo and Pt for example. A heater, generally contained in a sleeve adjacent the base, serves to heat the cathode base and the electron-emitting oxide layer.

In order to emit electrons from the cathode, reducing reactions occur at the interface between the base and the oxide-containing electron-emitting layer. The alkaline earth metal oxide components in the electron-emitting layer are reduced by reacting with the reducing components, or “activators”, present in the base. For example, BaO may be reduced in the following reactions:
BaO+Mg→MgO+Ba↑ (i)
4BaO+Si→Ba₂SiO₄+2 Ba↑ (ii)
thus liberating free barium which serves to emit electrons at the emission surface. Such reactions occur when the cathode is heated to a working temperature of around 700-850° C. The rate of reaction determines the maximum current which the cathode can supply.

It can be seen from reactions (i) and (ii) that MgO and Ba₂SiO₄ are respectively generated as by-products. Such solid deposits remain present at the interface and inhibit the diffusion of the activators to the reaction site. U.S. Pat. No. 6,390,877 discloses a cathode for an electron gun comprising a base metal composed of nickel and at least one kind of reducing component, and an upper metal layer formed between the surface of the base and an emitting oxide. The upper metal layer is formed of particles smaller than those of the base metal so as to disperse the diffusion path of the reducing component contained in the base metal.

However, throughout the lifetime of the cathode, the various layers are heated and cooled many times. The heating of a metal layer causes gradual crystallisation of the metal wherein grains progressively grow throughout that layer. As the metal (e.g nickel) grains increase in size the number of diffusion paths for the activators decreases thus creating increased resistance to their flow to the surface. It can clearly be seen from reactions (i) and (ii) that progressively reducing the supply of the activators (e.g. Mg and Si) limits the rate of reaction. This has a detrimental effect on the cathode performance and lifetime.

It is therefore an object of the invention to provide an improved oxide cathode.

It is a further object of the invention to provide an oxide cathode having an increased lifetime.

According to a first aspect of the present invention there is provided an oxide cathode having an indirectly heated electron emitting layer disposed on a cathode base layer and an interface layer between the electron emitting layer and the base layer wherein the interface layer comprises a plurality of sub layers, each adjacent sub layer being formed of a different material or materials, and wherein at least one sub-layer comprises at least one metal selected from nickel, cobalt, iridium, rhenium, palladium, rhodium and platinum.

Suitably the base layer comprises one or more metals and the interface layer comprises at least one metal present in the base layer.

Suitably the interface layer comprises a metal present as a major proportion of the base layer, as a major proportion of the interface layer, more preferably at least 50% w/w of the interface layer, more preferably at least 60 w/w, still more preferably at least 70% w/w, most preferably at least 80% w/w and especially at least 90% w/w.

By providing an interface layer comprising a plurality of elements grain growth can be confined to the interface layer whilst still leaving many diffusion paths for components e.g. reducing components in the base and/or electron emitting layers.

Suitably the base layer comprises at least one of Ni, Co, Ir, Re, Pd, Rh and Pt, preferably in a major proportion, suitably at least 50% w/w, preferably at least 60% w/w and more preferably at least 75% w/w.

Suitably the interface layer comprises a metal selected from; Ni, Co, Ir, Re, Pd, Rh, Pt, or alloy comprising any one or more of the aforesaid.

Preferably the metal is present in the interface layer in an amount of at least 50% w/w of the interface layer, more preferably at least 60% w/w, still more preferably at least 70% w/w, especially at least 80% w/w and most preferably at least 90% w/w.

Suitably the electron emitting layer comprises a metal oxide, more preferably an alkaline-earth metal oxide. Suitable alkaline earth metal oxides include BaO, SrO, CaO, Sc₂O₃, ThO₂, La₂O₃ and Y₂O₃.

Preferably the interface layer comprises at least one activator element, able to react with the metal oxide in the electron-emitting layer to release the metallic element from the metal oxide and itself form an oxide.

Each activator element is preferably independently present in the interface layer in an amount of no more than 10% w/w, preferably no more than 8% w/w and more preferably no more than 6% w/w. Each activator element is preferably independently present in interface layer in an amount of at least 0.01% w/w, more preferably at least 0.025% w/w and most preferably at least 0.5% w/w, especially at least 1% w/w.

Suitable activator elements include Al, Mg, W, Mn, Fe, Mo, Cr, Ti and Zr, for example.

The interface layer may typically comprise the following mixture:
Al 0-1% w/w
Mg 0-1% w/w
W 0-6% w/w
Ni to balance

The interface layer may comprise the same composition of metals present in the base layer, whether in identical proportions or different proportions.

Preferably at least one sub-layer comprises at least one metal selected from Ni, Co, Ir, Re, Pd, Rh and Pt and at least one further sub-layer comprises an activator element, especially W, Mg or Al.

By providing dissimilar adjacent layers at the interface between the electron-emitting layer and the base, grain growth can be confined within individual layers. This maintains fine grains at the interface and thus many diffusion paths for the reducing components, i.e. the activators.

According to a second aspect of the invention there is provided a method of manufacturing an oxide cathode having an indirectly heated electron emitting layer disposed on a cathode base layer and an interface layer between the electron emitting layer and the base layer, the method comprising forming an interface layer comprising a plurality of sub-layers, each adjacent sub-layer being formed of a different material or materials, wherein at least one sub-layer comprises a metal selected from nickel, cobalt, iridium, rhenium, palladium, rhodium or platinum, and forming an electron-emitting layer over the interface layer.

The method may comprise forming an interface layer comprising a plurality of sub-layers over the base layer, such that adjacent sub-layers are formed of dissimilar materials Each material may comprise a single chemical element or a plurality of chemical elements.

Preferably, the method comprises sputtering the interface layer onto the base layer, then forming the electron emitting layer over the interface layer.

The or each layer may be as described hereinabove for the first aspect of the invention.

Also, in accordance with the present invention, there is provided an oxide cathode, having one or more novel features or combinations of features as recited in the following description of embodiments of the invention.

Further features and advantages of the present invention will become apparent from reading of the following description of preferred embodiments, given by way of example only, and with reference to the accompanying drawings, in which:

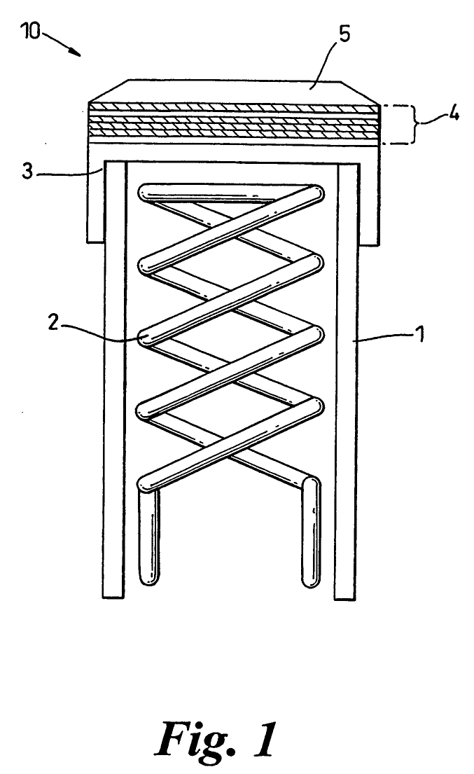

FIG. 1 is a diagrammatic cross-sectional view of an oxide cathode having a multiple layer interface coating in accordance with the invention;

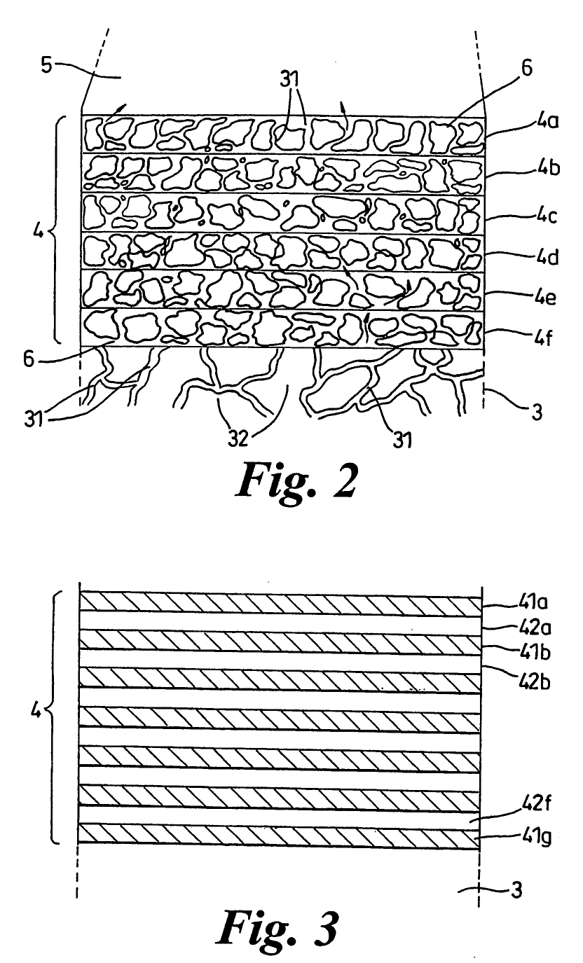

FIG. 2 is a highly magnified schematic sectional view of a multiple layer interface coating in accordance with the present invention;

FIGS. 3, 4 and 5 are cross-sectional views of various embodiments; and

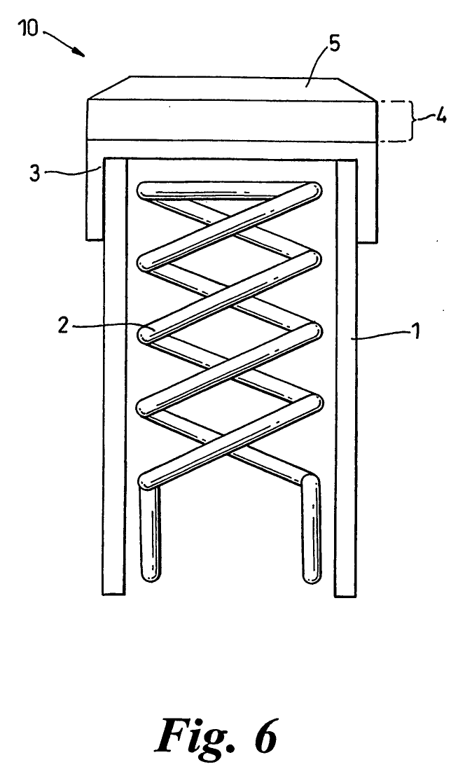

FIG. 6 is a diagrammatic cross-sectioned view of an oxide cathode having a single layer interface layer not in accordance with the invention.

It should be noted that the figures are not drawn to scale. The same reference numerals are used throughout the figures to denote the same or similar parts.

With reference to FIG. 1, an oxide cathode 10 comprises a tubular metallic sleeve 1 which houses a helical-shaped heater element 2. The upper end of the sleeve 1 is capped by a metal base 3. The base 3 is preferably formed from a metal alloy selected from the group consisting of Ni, Co, Ir, Re, Pd, Rh and Pt. Traditionally, a nickel alloy is used for the base material. The base 3 also comprises a reducing component such as Mg or Si. Other suitable reducing components or “activators” include Mn, Fe, W, Mo, Cr, Ti and Zr.

A multiple layer interface coating 4 is formed between the cathode base 3 and an electron-emitting layer 5. The electron-emitting layer 5 is formed by spraying a paste of oxide-containing material onto the interface coating 4 using conventional deposition processes. The layer 5 contains a main component comprising a rare earth metal oxide such as BaO, CaO or SrO.

Reduction reactions occur between the activator elements in the base 3 and the alkaline earth metal oxide elements in the electron-emitting layer 5 to produce electrons. For this process to occur sufficiently, the diffusion of the activators across the interface should have many available diffusion paths. The multiple layer interface coating 4 helps maintain a high rate of reaction throughout the lifetime of the cathode by restricting grain growth of the metal present at the coating 4.

The structure of the multiple layer interface coating 4 and its action to limit grain growth will now be described with reference to FIG. 2. The interface coating 4 comprises a plurality of thin layers 4a-f wherein adjacent layers are formed of different materials. Activators 31 present in the base 3 are dispersed amongst the large metal grains 32 of the base material. These diffuse through the metal grains 32 in the base to the interface coating 4.

The thin layers 4a-f of the interface coating each comprise fine-grained materials. This provides a high number of diffusion paths for the activators 31. The activators diffuse through the interface coating 4 to the electron-emitting layer 5 wherein they react with the alkaline earth metal oxides to produce electrons.

Throughout the lifetime of the cathode, the fine grains contained in the thin layers 4a-f grow. This grain growth is particularly evident when the layers are heated. Due to the adjacent thin layers (e.g 4c and 4d) being formed of different materials, the grains in one layer cannot grow beyond the boundaries with adjacent layers. Therefore, the thickness of the respective individual thin layers 4a-f determines the maximum size to which the grains can grow. Advantageously, this prevents grain growth beyond the interfaces between thin layers. By limiting the growth of the fine-grains at the interface between the base and the electron-emitting layer 5, diffusion paths for the activators are maintained thus increasing the performance and lifetime of the cathode 10.

The thin layers 4a-f are formed using Magnetron Sputter Coating. However, other plasma and chemical vapour deposition techniques may be employed such as DC sputtering. The dissimilar composition of adjacent layers can be achieved by alteration of the sputtering conditions throughout the coating process. The composition of each layer preferably comprises, at least as a component, nickel, tungsten, aluminium and/or magnesium. The thickness of each individual layer 4a-f lies in the range between 0.01 nm and 500 nm. The thin layers 4a-f are not necessarily formed to the same thickness as one another.

FIG. 3 shows a first example of an interface coating 4 according to the invention. The coating 4 comprises thirteen thin layers formed alternately from nickel 41a-g and tungsten 42a-f. Each thin layer is formed to a substantially equal thickness of 5 nm such that the total thickness of the coating is around 65 nm. The dissimilar layers are formed from fine grains which provide many diffusion paths for the activators to move from the base 3 to the electron-emitting layer 5.

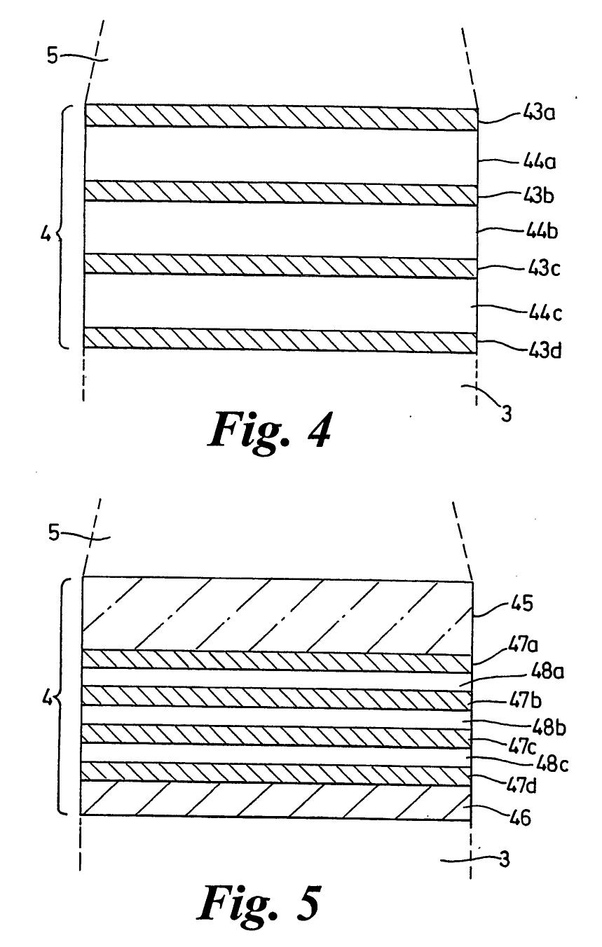

FIG. 4 shows a second example of an interface coating 4 according to the invention. The coating 4 comprises seven thin layers formed of alternate layers of nickel 43a-d and tungsten 44a-c. Each nickel layer is formed having a thickness of 100 nm and each tungsten layer having a thickness of 1 nm.

FIG. 5 shows a third example of an interface coating 4 according to the invention. Alternate layers of 1 nm thickness nickel 47a-d and tungsten 48a-c are sandwiched between “keying” layers 45, 46. A top keying layer 45 contacts the electron-emitting layer 5 and is formed of aluminium to a thickness of 20 nm. A bottom keying layer 46 contacts the cathode base 3 and is formed of magnesium to a thickness of 10 nm. Advantageously, the keying layers provide good bonding characteristics and ensure good adhesion between the base layer 3 and the electron-emitting layer 5.

Although the aforementioned examples have described the thin layers as being formed from a single metal (e.g nickel), it is envisaged that the layers may comprise a composition, or alloy, of different metals/materials. For example a layer may consist of a composition of nickel, tungsten, magnesium and aluminium. Adjacent dissimilar layers may comprise different compositions or different ratios of materials within the same composition. For example, an interface coating 4 may comprise alternate layers of [92% Ni:6% W:1% Mg:1% Al] and [97% Ni:1% W:1% Mg:1% Al]. It should be noted that Mg or Al layers are preferably covered by a layer formed of a relatively noble metal, e.g. Ni or W, to prevent oxidation of the Mg/Al during further processing steps.

In other embodiments of the invention the interface layer 4 may comprise only a single layer comprising a plurality of different elements. The plurality of different elements may be in the form of an alloy or other mixture of metallic elements and/or metals. A suitable alloy may comprise 92% Ni, 6% W, 1% Mg and 1% Al for example. Alternatively the single layer comprising a plurality of different elements may comprise a plurality of different materials, such as two or more alloys, for example a layer comprising both an 92% Ni, 6% W, 1% Mg, 1% Al alloy and a 97% Ni, 1% W, 1% Mg, 1% Al alloy.

FIG. 6 illustrates a cross-sectional, diagrammatic view of an oxide cathode not of the invention similar to that shown in FIG. 1, like numerals represent like components. It can be seen that the interface layer 4 comprises only a single layer, which includes a plurality of different elements, comprising an alloy, or a plurality of different alloys or composite materials for example.

From reading the description, modifications and variations will be apparent to persons skilled in the art. Such modifications and variations may involve other features which are already known in the art and which may be used instead of or in addition to features already disclosed herein. No specific patent claims have yet been formulated in this application to particular combinations of features, and it should be understood that the scope of the disclosure of the present application includes any and every novel feature or combination of features disclosed herein either explicitly or implicitly and together with all such modifications and variations, whether or not relating to the main inventive concepts disclosed herein and whether or not it mitigates any or all of the same technical problems as the main inventive concepts. The applicants hereby give notice that patent claims may be formulated to such features and/or combinations of such features during prosecution of the present application or of any further application derived or claiming priority therefrom.

1. An oxide cathode having an indirectly heated electron emitting layer disposed on a cathode base layer and an interface layer between the electron emitting layer and the base layer wherein the interface layer comprises a plurality of sub layers, each adjacent sub layer being formed of a different material or materials, and wherein at least one sub-layer comprises at least one metal selected from nickel, cobalt, iridium, rhenium, palladium, rhodium and platinum.

2. An oxide cathode as claimed in claim 1, wherein the base layer comprises one or more metals and the interface layer comprises at least one metal present in the base layer.

3. An oxide cathode as claimed in claim 1, wherein the base layer comprises a major proportion of one metal and the interface layer comprises, as a major proportion of the interface layer, the metal present as a major proportion of the base layer.

4. An oxide cathode as claimed in claim 1, wherein the base layer comprises at least one of nickel, cobalt, iridium, rhenium, palladium, rhodium and platinum.

5. An oxide cathode as claimed in claim 1, wherein the metal is present in the interface layer in an amount of at least 50% w/w of the interface layer.

6. An oxide cathode as claimed in claim 1, wherein the electron emitting layer comprises a metal oxide.

7. An oxide cathode as claimed in claim 6, wherein at least one sub-layer of the interface layer comprises at least one activator element, able to react with the metal oxide in the electron-emitting layer to release the metallic element from the metal oxide and itself form an oxide.

8. An oxide cathode as claimed in claim 7, wherein each activator element is independently present in the interface sub-layer in an amount of no more then 10% w/w.

9. An oxide cathode as claimed in claim 7, wherein the activator element is selected from aluminum, magnesium, tungsten, manganese, iron, molybdenum, chromium, titanium and zirconium.

10. A method of manufacturing an oxide cathode having an indirectly heated electron emitting layer disposed on a cathode base layer and an interface layer between the electron emitting layer and the base layer, the method comprising forming an interface layer comprising a plurality of sub-layers, each adjacent sub-layer being formed of a different material or materials, wherein at least one sub-layer comprises a metal selected from nickel, cobalt, iridium, rhenium, palladium, rhodium or platinum, and forming an electron-emitting layer over the interface layer.

11. A method as claimed in claim 11, comprising forming an interface layer comprising a plurality of sub-layers over the base layer, such that adjacent layers are formed of dissimilar materials.

12. A method as claimed in claim 10, wherein the method comprises sputtering the interface layer or sub-layers onto the base layer, then forming the electron emitting layer over the interface layer.

13. An oxide cathode as claimed in claim 2, wherein the base layer comprises at least one of nickel, cobalt, iridium, rhenium, palladium, rhodium and platinum.

14. An oxide cathode as claimed in claim 3, wherein the base layer comprises at least one of nickel, cobalt, iridium, rhenium, palladium, rhodium and platinum.

15. An oxide cathode as claimed in claim 2, wherein the metal is present in the interface layer in an amount of at least 50% w/w of the interface layer.

16. An oxide cathode as claimed in claim 3, wherein the metal is present in the interface layer in an amount of at least 50% w/w of the interface layer.

17. An oxide cathode as claimed in claim 4, wherein the metal is present in the interface layer in an amount of at least 50% w/w of the interface layer.

18. An oxide cathode as claimed in claim 2, wherein the electron emitting layer comprises a metal oxide.

19. An oxide cathode as claimed in claim 3, wherein the electron emitting layer comprises a metal oxide.

20. An oxide cathode as claimed in claim 4, wherein the electron emitting layer comprises a metal oxide.

21. An oxide cathode as claimed in claim 5, wherein the electron emitting layer comprises a metal oxide.

22. An oxide cathode as claimed in claim 8, wherein the activator element is selected from aluminum, magnesium, tungsten, manganese, iron, molybdenum, chromium, titanium and zirconium.

23. A method as claimed in claim 11, wherein the method comprises sputtering the interface layer or sub-layers onto the base layer, then forming the electron emitting layer over the interface layer.
